(19) United States
(12) Patent Application Publication
(10) Pub. No.: US 2025/0191565 A1
(43) Pub. Date: Jun. 12, 2025

(54) VENTILATION TYPE SILENCER

(71) Applicant: FUJIFILM Corporation, Tokyo (JP)

(72) Inventors: Shinya HAKUTA, Ashigarakami-gun (JP); Shun ISHIGE, Ashigarakami-gun (JP); Yoshihiro SUGAWARA, Ashigarakami-gun (JP); Tomohiro TAKAHASHI, Ashigarakami-gun (JP); Shogo YAMAZOE, Ashigarakami-gun (JP); Yuichiro ITAI, Ashigarakami-gun (JP)

(73) Assignee: FUJIFILM Corporation, Tokyo (JP)

(21) Appl. No.: 19/060,979

(22) Filed: Feb. 24, 2025

Related U.S. Application Data
(63) Continuation of application No. PCT/JP2023/026988, filed on Jul. 24, 2023.

(30) Foreign Application Priority Data
Sep. 28, 2022 (JP) 2022-155019

(51) Int. Cl. G10K 11/16; F24F 13/24; G10K 11/162

(52) U.S. Cl. CPC G10K 11/161; F24F 13/24; G10K 11/162; F24F 2013/242

(57) ABSTRACT

Provided is a ventilation type silencer that can suppress occurrence of condensation in a rear space and reduce generation of wind noise and a pressure loss in a flow passage space.

A ventilation type silencer has an inlet side ventilation pipe, an expansion portion that communicates with the inlet side ventilation pipe and that has a cross-sectional area larger than that of the inlet side ventilation pipe, an outlet side ventilation pipe that communicates with the expansion portion and that has a cross-sectional area smaller than that of the expansion portion, a flow passage wall that is disposed in the expansion portion, that causes the inlet side ventilation pipe and the outlet side ventilation pipe to communicate with each other, and that has at least a part including a porous sound absorbing material, and a rear space that is positioned on a side opposite to a flow passage space in the flow passage wall with the flow passage wall interposed therebetween and that is defined by the flow passage wall and a housing of the expansion portion, in which the porous sound absorbing material has one or a plurality of communication paths that cause the flow passage space and the rear space to communicate with each other.

### CROSS-REFERENCE TO RELATED APPLICATIONS

This application is a Continuation of PCT International Application No. PCT/JP2023/026988 filed on Jul. 24, 2023, which claims priority under 35 U.S.C. § 119(a) to Japanese Patent Application No. 2022-155019 filed on Sep. 28, 2022. The above applications are hereby expressly incorporated by reference, in their entirety, into the present application.

### BACKGROUND OF THE INVENTION

### 1. Field of the Invention

The present invention relates to a ventilation type silencer.

### 2. Description of the Related Art

In general, a ventilation type silencer having an inlet side ventilation pipe, an expansion portion that communicates with the inlet side ventilation pipe and that has a cross-sectional area larger than that of the inlet side ventilation pipe, and an outlet side ventilation pipe that communicates with the expansion portion and that has a cross-sectional area smaller than that of the expansion portion is known.

As such a ventilation type silencer, a ventilation type silencer comprising a flow passage wall that is disposed in an expansion portion and that is formed of a porous sound absorbing material and a rear space that is positioned on a side opposite to a flow passage space in the flow passage wall with the flow passage wall interposed therebetween and that is defined by the flow passage wall and a housing of the expansion portion is known (for example, see JP1994-167982A (JP-H-6-167982A)).

### SUMMARY OF THE INVENTION

In the above ventilation type silencer, condensation occurs in the rear space in some cases.

In addition, in the above ventilation type silencer, it is required to reduce generation of wind noise and a pressure loss in the flow passage space.

An object of the present invention is to solve the above problems of the related art and to provide a ventilation type silencer that can suppress occurrence of condensation in a rear space and reduce generation of wind noise and a pressure loss in a flow passage space.

In order to achieve the object, the present invention has the following configurations.

[1] A ventilation type silencer comprising:

an inlet side ventilation pipe;

an expansion portion that communicates with the inlet side ventilation pipe and that has a cross-sectional area larger than that of the inlet side ventilation pipe;

an outlet side ventilation pipe that communicates with the expansion portion and that has a cross-sectional area smaller than that of the expansion portion;

a flow passage wall that is disposed in the expansion portion, that causes the inlet side ventilation pipe and the outlet side ventilation pipe to communicate with each other, and that has at least a part including a porous sound absorbing material; and

a rear space that is positioned on a side opposite to a flow passage space in the flow passage wall with the flow passage wall interposed therebetween and that is defined by the flow passage wall and a housing of the expansion portion,

in which the porous sound absorbing material has one or a plurality of communication paths that cause the flow passage space and the rear space to communicate with each other.

[2] The ventilation type silencer according to [1],

in which an equivalent circle opening diameter of the communication path is 1.0 mm to 50.0 mm.

[3] The ventilation type silencer according to [1] or [2],

in which permeability of the porous sound absorbing material is 1.0×10⁻¹³ m² to 5.0×10⁻⁹ m² or 13.0×10⁻⁹ m² to 1.0×10⁻⁵ m².

[4] The ventilation type silencer according to any one of [1] to [3],

in which in a case where opening areas of the one or plurality of communication paths are added up, a total is 20 mm² or more.

[5] The ventilation type silencer according to any one of [1] to [4],

in which the plurality of communication paths are provided at an interval along a flowing direction of a gas flowing in the flow passage space.

[6] The ventilation type silencer according to any one of [1] to [5],

in which a dust filter is disposed at the communication path.

[7] The ventilation type silencer according to any one of [1] to [6],

in which the housing of the expansion portion is made of a resin.

[8] The ventilation type silencer according to any one of [1] to [7],

in which a temperature of a gas flowing in the flow passage space is 20° C. to 80° C. and is high compared to a temperature outside the expansion portion.

[9] The ventilation type silencer according to any one of [1] to [8],

in which an inner surface of the flow passage space is composed of a surface of the porous sound absorbing material and a surface of the housing of the expansion portion, and the communication path is provided to be in contact with the surface of the housing of the expansion portion.

[10] The ventilation type silencer according to any one of [1] to [9],

in which the porous sound absorbing material has a first surface that is in contact with a gas in the flow passage space and a second surface that is in contact with a gas in the rear space, and

the one or plurality of communication paths penetrate from the first surface to the second surface.

[11] The ventilation type silencer according to any one of [1] to [10],

in which a cross section of the flow passage space perpendicular to a flowing direction is rectangular,

an inner surface of the flow passage space is composed of a surface of each of the porous sound absorbing material and the housing which face each other in a first direction intersecting the flowing direction and a surface of each of a pair of the porous sound absorbing materials which face each other in a second direction intersecting the flowing direction and the first direction, and

the communication path is formed in each of three surfaces of the porous sound absorbing material, which constitute the inner surface of the flow passage space.

[12] The ventilation type silencer according to any one of [1] to [11],

in which the communication path is a through-hole.

[13] The ventilation type silencer according to any one of [1] to [12],

in which the communication path is configured by cutting out one end of the porous sound absorbing material.

According to the present invention, the ventilation type silencer that can suppress the occurrence of condensation in the rear space and reduce the generation of wind noise and a pressure loss in the flow passage space can be provided.

### BRIEF DESCRIPTION OF THE DRAWINGS

FIG. 1 is a cross-sectional view conceptually showing an example of a ventilation type silencer according to an embodiment of the present invention.

FIG. 2 is a cross-sectional view taken along line A-A of FIG. 1.

FIG. 3 is a cross-sectional view conceptually showing another example of the ventilation type silencer according to the embodiment of the present invention.

FIG. 4 is a perspective view conceptually showing the ventilation type silencer of FIG. 3.

FIG. 5 is a cross-sectional view taken along line B-B of FIG. 4.

FIG. 6 is a cross-sectional view conceptually showing still another example of the ventilation type silencer according to the embodiment of the present invention.

FIG. 7 is a perspective view conceptually showing still another example of the ventilation type silencer according to the embodiment of the present invention.

FIG. 8 is a cross-sectional view taken along line C-C of FIG. 7.

FIG. 9 is a perspective view conceptually showing still another example of the ventilation type silencer according to the embodiment of the present invention.

FIG. 10 is a cross-sectional view taken along line D-D of FIG. 9.

FIG. 11 is a perspective view conceptually showing still another example of the ventilation type silencer according to the embodiment of the present invention.

FIG. 12 is a view showing another example of a communication path provided in a porous sound absorbing material.

FIG. 13 is a view showing still another example of the communication path provided in the porous sound absorbing material.

FIG. 14 is a view showing still another example of the communication path provided in the porous sound absorbing material.

FIG. 15 is a view showing still another example of the communication path provided in the porous sound absorbing material.

FIG. 16 is a view showing still another example of the communication path provided in the porous sound absorbing material.

FIG. 17 is a front view conceptually showing a ventilation type silencer according to example 1 of the present invention.

FIG. 18 is a plan view conceptually showing the ventilation type silencer according to example 1 of the present invention.

FIG. 19 is a front view conceptually showing a ventilation type silencer according to example 2 of the present invention.

FIG. 20 is a plan view conceptually showing the ventilation type silencer according to example 2 of the present invention.

FIG. 21 is a graph showing a vorticity in example 1.

FIG. 22 is a graph showing a vorticity in comparative example 1.

FIG. 23 is a graph showing a relationship between a frequency and transmittance in example 1.

FIG. 24 is a graph showing a relationship between the frequency and a transmission loss in example 1.

FIG. 25 is a graph showing a relationship between a frequency and transmittance in comparative example 1.

FIG. 26 is a graph showing a relationship between the frequency and a transmission loss in comparative example 1.

FIG. 27 is a graph showing a relationship between a frequency and transmittance in comparative example 2.

FIG. 28 is a graph showing a relationship between the frequency and a transmission loss in comparative example 2.

FIG. 29 is a graph showing a relationship between the frequency and the transmission loss in examples 1 and 2.

FIG. 30 is a graph showing a relationship between permeability and a wind noise amount in examples 1 and 2.

FIG. 31 is a graph showing a relationship between permeability and a wind noise amount in example 3.

### DESCRIPTION OF THE PREFERRED EMBODIMENTS

Hereinafter, a ventilation type silencer according to an embodiment of the present invention will be described in detail.

Description of configuration requirements written below is provided based on representative embodiments of the present invention, but the present invention is not limited to such embodiments.

In the present specification, numerical ranges represented by “to” include numerical values before and after “to” as a lower limit value and an upper limit value, respectively.

In addition, in the present specification, the terms “perpendicular” and “parallel” include a range of an error accepted in a technical field to which the present invention belongs. For example, the terms “perpendicular” and “parallel” mean a range less than ±10° with respect to strict perpendicular or parallel, and an error with respect to strict perpendicular or parallel is preferably equal to or less than 5° and more preferably equal to or less than 3°.

In the present specification, the terms such as “identical” and “the same” may include a range of an error generally accepted in the technical field.

In addition, in the present specification, an arrangement direction of an inlet side ventilation pipe, an expansion portion, and an outlet side ventilation pipe is defined as an X-direction, a first direction orthogonal to the arrangement direction is defined as a Y-direction, and a second direction orthogonal to the arrangement direction and the first direction is defined as a Z-direction.

### Ventilation Type Silencer

A ventilation type silencer according to the embodiment of the present invention comprising:

an inlet side ventilation pipe;

an expansion portion that communicates with the inlet side ventilation pipe and that has a cross-sectional area larger than that of the inlet side ventilation pipe;

an outlet side ventilation pipe that communicates with the expansion portion and that has a cross-sectional area smaller than that of the expansion portion;

a flow passage wall that is disposed in the expansion portion and that has at least a part including a porous sound absorbing material while causing the inlet side ventilation pipe and the outlet side ventilation pipe to communicate with each other; and

a rear space that is positioned on a side opposite to a flow passage space in the flow passage wall with the flow passage wall interposed therebetween and that is defined by the flow passage wall and a housing of the expansion portion,

in which the porous sound absorbing material has one or a plurality of communication paths that cause the flow passage space and the rear space to communicate with each other.

### Example of Embodiment

A configuration of the ventilation type silencer according to the embodiment of the present invention will be described with reference to the drawings.

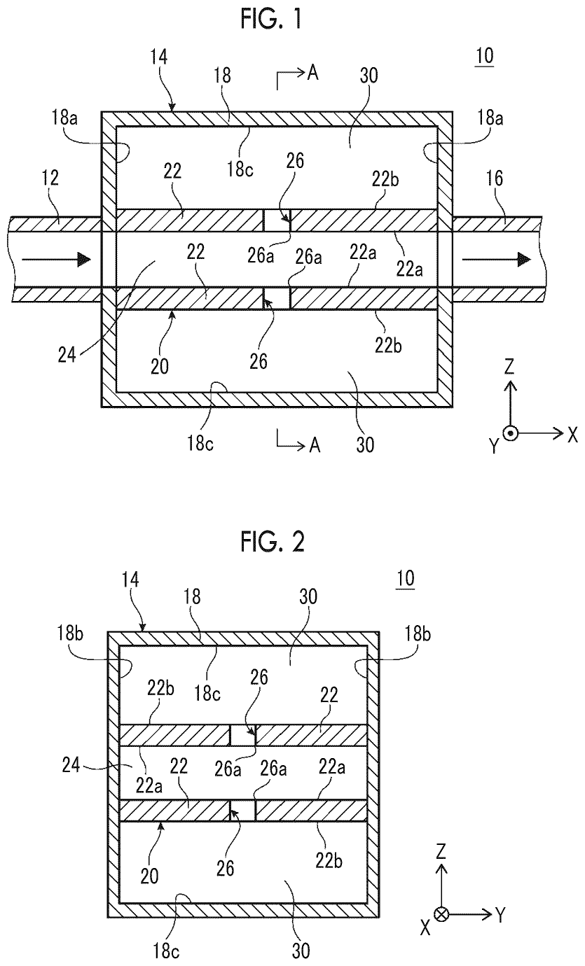

FIG. 1 is a cross-sectional view conceptually showing an example of the ventilation type silencer according to the embodiment of the present invention. FIG. 2 is a cross-sectional view taken along line A-A of FIG. 1.

A ventilation type silencer 10 shown in FIG. 1 has a tubular inlet side ventilation pipe 12, an expansion portion 14 connected to one opening edge surface of the inlet side ventilation pipe 12, and a tubular outlet side ventilation pipe 16 connected to an edge surface of the expansion portion 14 on a side opposite to the inlet side ventilation pipe 12.

A temperature and humidity of a gas flowing in the ventilation type silencer 10 vary depending on a form in which the ventilation type silencer 10 is used. In this example, the gas flowing in the ventilation type silencer 10 is assumed to have a high temperature and high humidity, and the temperature of the gas is higher than a temperature outside the expansion portion 14. Specifically, a temperature range is assumed to be 20° C. to 80° C., and a humidity range is assumed to be 50 to 95% RH.

### Ventilation Pipe

The inlet side ventilation pipe 12 is a tubular member and transports a gas, which has flowed in from one opening edge surface thereof, to the expansion portion 14 connected to the other opening edge surface thereof.

The outlet side ventilation pipe 16 is a tubular member, communicates with the expansion portion 14, and transports a gas, which has flowed in from one opening edge surface thereof connected to the expansion portion 14, to the other opening edge surface thereof. The outlet side ventilation pipe 16 has a cross-sectional area smaller than that of the expansion portion 14.

Cross-sectional shapes of the inlet side ventilation pipe 12 and the outlet side ventilation pipe 16 (hereinafter, also collectively referred to as a ventilation pipe) may be various shapes, such as a circular shape, a rectangular shape, and a triangular shape. In addition, the cross-sectional shape of the ventilation pipe may not be constant in an axial direction of a central axis of the ventilation pipe. For example, a diameter of the ventilation pipe may be changed in the axial direction.

The inlet side ventilation pipe 12 and the outlet side ventilation pipe 16 may have the same cross-sectional shape and cross-sectional area or may have different shapes and/or cross-sectional areas. In addition, in an example shown in FIG. 1, the inlet side ventilation pipe 12 and the outlet side ventilation pipe 16 are disposed such that central axes thereof match each other. However, without being limited thereto, the central axis of the inlet side ventilation pipe 12 and the central axis of the outlet side ventilation pipe 16 may be offset from each other.

Sizes (cross-sectional areas or the like) of the inlet side ventilation pipe 12 and the outlet side ventilation pipe 16 may be set as appropriate according to a size of a device in which the ventilation type silencer is used, a required ventilation performance, and the like.

Examples of a material for forming the ventilation pipe include a metal material, a resin material, a reinforced plastic material, and a carbon fiber. Examples of the metal material include metal materials such as aluminum, titanium, magnesium, tungsten, iron, steel, chromium, chromium molybdenum, nichrome molybdenum, and alloys thereof. Examples of the resin material include resin materials such as acrylic resin (PMMA), polymethyl methacrylate, polycarbonate, polyamidimide, polyalylate, polyetherimide, polyacetal, polyetheretherketone, polyphenylene sulfide, polysulfone, polyethylene terephthalate, polybutylene terephthalate (PBT), polyimide, triacetylcellulose (TAC), polypropylene (PP), polyethylene (PE), polystyrene (PS), ABS resin (copolymer synthetic resin of acrylonitrile, butadiene, and styrene), flame-retardant ABS resin, ASA resin (copolymer synthetic resin of acrylonitrile, styrene, and acrylate), polyvinyl chloride (PVC) resin, and polylactic acid (PLA) resin. In addition, examples of the reinforced plastic material include carbon fiber reinforced plastics (CFRP) and glass fiber reinforced plastics (GFRP).

### Expansion Portion

The expansion portion 14 is disposed between the inlet side ventilation pipe 12 and the outlet side ventilation pipe 16, communicates with the inlet side ventilation pipe 12, and transports a gas, which has flowed in from the inlet side ventilation pipe 12, to the outlet side ventilation pipe 16. In the examples shown in FIGS. 1 and 2, the expansion portion 14 has a housing 18 that constitutes an outer edge of the expansion portion 14. The housing 18 has a substantially hollow rectangular parallelepiped shape extending in the X-direction, the inlet side ventilation pipe 12 is connected to one side surface thereof in the X-direction, and the outlet side ventilation pipe 16 is connected to the other side surface thereof facing the one side surface. The central axis of the inlet side ventilation pipe 12 is positioned at a center of the one side surface, and the central axis of the outlet side ventilation pipe 16 is positioned at a center of the other side surface facing the one side surface.

The expansion portion 14 has a cross-sectional area perpendicular to the X-direction that is larger than the cross-sectional area of the inlet side ventilation pipe 12 and that is larger than the cross-sectional area of the outlet side ventilation pipe 16. That is, for example, in a case where the cross-sectional shapes of the inlet side ventilation pipe 12, the outlet side ventilation pipe 16, and the expansion portion 14 are circular, a diameter of the cross section of the expansion portion 14 is larger than diameters of the inlet side ventilation pipe 12 and the outlet side ventilation pipe 16.

The cross-sectional shape of the expansion portion 14 may be various shapes, such as a circular shape, a rectangular shape, and a triangular shape. In addition, the cross-sectional shape of the expansion portion 14 may not be constant in the axial direction (X-direction) of the central axis of the expansion portion 14. For example, the diameter of the expansion portion 14 may be changed in the axial direction. In the example shown in FIG. 1, the cross section of the expansion portion 14 is rectangular, and the cross-sectional shape is constant in the X-direction.

The size (the length, the cross-sectional area, or the like) of the expansion portion 14 may be set as appropriate according to the size of the device in which the ventilation type silencer is used, a required silencing performance, and the like.

Examples of a material for forming the housing 18 are the same as those for the ventilation pipe and include a metal material, a resin material, a reinforced plastic material, and a carbon fiber. Details of the material are as described above in the description of the ventilation pipe. In the example shown in FIG. 1, the housing 18 is made of a resin.

The housing 18 is configured by, for example, disposing a plurality of (six in the example shown in FIG. 1) plate materials in a box shape and bonding the plate materials adjacent to each other with an adhesive, a gluing agent, solder, fusion welding, or the like. Alternatively, in a case where the housing 18 is divided into two parts and fragmented, the housing 18 may be configured by producing each fragment through injection molding, a 3D printer, or the like and combining the fragments with each other.

### Flow Passage Wall

A flow passage wall 20 is disposed in the expansion portion 14 (more specifically, the housing 18). With a region that causes the inlet side ventilation pipe 12 and the outlet side ventilation pipe 16 to communicate with each other and that linearly connects the inlet side ventilation pipe 12 and the outlet side ventilation pipe 16 as a flow passage, the flow passage wall 20 is disposed to surround the flow passage. A flow passage space 24 (flow passage) surrounded by the flow passage wall 20 has a rectangular cross section perpendicular to the X-direction.

In this example, a flowing direction of a gas flowing in the flow passage space 24 matches the X-direction (the arrangement direction of the inlet side ventilation pipe 12, the expansion portion 14, and the outlet side ventilation pipe 16).

At least a part of the flow passage wall 20 is composed of a porous sound absorbing material 22. As shown in FIG. 2, the flow passage wall 20 is composed of a pair of porous sound absorbing materials 22 disposed at an interval in the Z-direction and a pair of side walls that are a part of the housing 18 and that are disposed at an interval in the Y-direction. Ends of the porous sound absorbing material 22 in the X-direction and the Y-direction are in contact with surfaces 18a and 18b of the housing 18 on an inner side, respectively. With such a configuration, the flow passage wall 20 partitions the flow passage space 24 from an inner space in the housing 18.

### Rear Space

A rear space 30 is positioned on a side opposite to the flow passage space 24 (hereinafter, also referred to as a rear surface side) with the flow passage wall 20 interposed therebetween. The rear space 30 suppresses return of a sound wave that has entered from the flow passage space 24 and that reflects from the porous sound absorbing material 22, which is a part of the flow passage wall 20, to the flow passage space 24. That is, in a case where the rear surface side of the porous sound absorbing material 22 is in direct contact with the housing 18, the sound wave that has entered the porous sound absorbing material 22 from the flow passage space 24 reflects from the housing 18 and returns to the flow passage space 24. In the ventilation type silencer 10, the provision of the rear space 30 suppresses the reflection of the sound wave and the return of the sound wave to the flow passage space 24.

In the example shown in FIG. 1, the two rear spaces are positioned on both outer sides of the flow passage wall 20 in the Z-direction. The rear space 30 is defined by the flow passage wall 20 and the housing 18 of the expansion portion 14. More specifically, as shown in FIGS. 1 and 2, the rear space 30 is surrounded by a second surface 22b that is an outer surface of the flow passage wall 20 in the Z-direction, a surface 18c of the housing 18 that faces the second surface 22b in the Z-direction, a pair of surfaces 18a of the housing 18 that face each other in the X-direction, and a pair of surfaces 18b of the housing 18 that face each other in the Y-direction.

From a viewpoint of a silencing performance, a depth of the rear space 30 in a direction perpendicular to the second surface 22b of the flow passage wall, that is, the Z-direction in the example shown in FIG. 1 is preferably 10 mm to 400 mm and more preferably 30 mm to 200 mm. In addition, from the viewpoint of the silencing performance, the depth of the rear space 30 is preferably two to twenty times the thickness of the porous sound absorbing material 22 and more preferably three to ten times the thickness of the porous sound absorbing material 22.

### Porous Sound Absorbing Material

As described above, the porous sound absorbing material 22 is included in a part of the flow passage wall 20. The porous sound absorbing material 22 converts sound energy of a sound wave passing through an inside thereof into thermal energy to absorb the sound wave. In the examples shown in FIGS. 1 and 2, the entire region of the flow passage wall 20 is composed of the porous sound absorbing material 22.

As shown in FIGS. 1 and 2, the porous sound absorbing material 22 is, for example, a plate member having a rectangular shape in plan view. Among six surfaces constituting the porous sound absorbing material 22, a pair of surfaces that are widest are a first surface 22a and the second surface 22b that face each other in the Z-direction. Each of the first surface 22a and the second surface 22b is a rectangular surface extending in the X-direction and the Y-direction. The first surface 22a faces the flow passage space 24 and is in contact with a gas in the flow passage space 24. No other components are present between the first surface 22a and the flow passage space 24. The second surface 22b faces the rear space 30 and is in contact with a gas in the rear space 30. No other components are present between the second surface 22b and the rear space 30.

Four side surfaces of the porous sound absorbing material 22 rise on four sides forming an outer edge of the first surface 22a, and the four side surfaces are connected to four sides forming an outer edge of the second surface 22b, respectively. Among the four side surfaces, two side surfaces facing each other in the X-direction are in contact with the surface 18a of the housing 18 in the X-direction, and two side surfaces facing each other in the Y-direction are in contact with the surface 18b of the housing 18 in the Y-direction.

The porous sound absorbing material 22 is not particularly limited, and a known sound absorbing material in the related art can be used as appropriate. For example, various known sound absorbing materials such as a foaming body, a foaming material (foaming urethane foam (for example, CALMFLEX F manufactured by INOAC Corporation, urethane foam manufactured by Hikari Co., Ltd., Everlight manufactured by Archem Inc., Achilles Acron manufactured by Achilles Co., Ltd., and the like), flexible urethane foam, a ceramic particle sintered material, phenol foam, melamine foam, a polyamide foam, and the like), a nonwoven fabric sound absorbing material (a microfiber nonwoven fabric (for example, Thinsulate manufactured by 3M Company and the like), a polyester nonwoven fabric (for example, White Kyuon manufactured by TOKYO Bouon and QonPET manufactured by Bridgestone KBG Co., Ltd. and such products are provided even in the form of a two-layer configuration with a high-density thin surface nonwoven fabric and a low-density rear surface nonwoven fabric), a plastic nonwoven fabric such as an acrylic fiber nonwoven fabric, a natural fiber nonwoven fabric such as wool and felt, a metal nonwoven fabric, a glass nonwoven fabric, and the like), and a material including a minute amount of air (glass wool, rock wool, and a nanofiber-based fiber sound absorbing material (silica nanofiber and acrylic nanofiber (for example, XAI manufactured by Mitsubishi Chemical Corporation))) can be used.

In addition, a sound absorbing material having a two-layer configuration that includes a high-density thin surface nonwoven fabric and a low-density rear surface nonwoven fabric may also be used.

The size, the type, and the like of the porous sound absorbing material 22 may be set as appropriate according to a silencing performance (a silencing frequency and the amount of silenced sound), the amount of ventilation, and the like required for the ventilation type silencer 10.

The thickness of the porous sound absorbing material 22 in the direction perpendicular to the second surface 22b, that is, the Z-direction in the example shown in FIG. 1 may be set as appropriate to a thickness at which a desired silencing performance is obtained, according to a flow resistance, porosity, a labyrinth degree, and the like of the porous sound absorbing material 22. From the viewpoint of the silencing performance, the thickness of the porous sound absorbing material 22 in the Z-direction is preferably 3 mm to 50 mm, more preferably 5 mm to 30 mm, and most preferably 10 mm to 20 mm.

### Communication Path

The porous sound absorbing material 22 further has a communication path 26 that penetrates from the first surface 22a to the second surface 22b and that causes the flow passage space 24 and the rear space 30 to communicate with each other.

As shown in FIG. 1, the communication path 26 is a through-hole that penetrates (communicates) the first surface 22a perpendicularly and has a hollow cylindrical shape. The communication path 26 is a through-hole that extends linearly without bending, and a central axis of the communication path 26 has straightness. An inner peripheral surface of the communication path 26 is composed of a surface of the porous sound absorbing material 22. As shown in FIG. 1, the communication path 26 is provided at a center of the first surface 22a, and more specifically, the communication path 26 is provided at a position where a central line that divides the first surface 22a into two equal parts in the X-direction and a central line that divides the first surface 22a into two equal parts in the Y-direction intersect each other.

A cross section of the communication path 26 perpendicular to a communication direction is circular. An opening diameter of the communication path 26 is preferably 1.0 mm to 50.0 mm and more preferably 3 mm to 20 mm. Hole diameters of a plurality of fine holes formed in the porous sound absorbing material 22 are generally 100 μm or less and are different from the opening diameter of the communication path 26. More specifically, the hole diameters of the fine holes in the porous sound absorbing material 22 are 1/10 or less of a minimum value of the opening diameter in the communication path 26, which are 1.0 mm.

In this example, the communication path 26 is a through-hole formed in the porous sound absorbing material 22 in a post-process of a forming process (for example, foam forming) of the porous sound absorbing material 22, separately from the forming process. However, without being limited thereto, the communication path 26 may be integrally formed in the forming process of the porous sound absorbing material 22.

As shown in FIGS. 1 and 2, a corner portion 26a is formed at a connection point between the inner peripheral surface of the communication path 26 and the first surface 22a. The corner portion 26a extends along a circumferential direction around the central axis of the communication path 26 and surrounds a periphery of the communication path 26.

### Action and Effect

As described above, in the ventilation type silencer 10, the porous sound absorbing material 22 has the communication path 26 that penetrates from the first surface 22a to the second surface 22b and that causes the flow passage space 24 and the rear space 30 to communicate with each other. Accordingly, a gas flowing in the flow passage space 24 is transported to the rear space 30 via the communication path 26. As a result, the rear space 30 is less likely to have a low temperature and high humidity, and occurrence of condensation in the rear space 30 is suppressed.

Description will be made in more detail using an example of a case where the porous sound absorbing material 22 does not have the communication path 26. A state where a temperature in the rear space 30 decreases such that the rear space 30 is sufficiently cooled by air outside the expansion portion 14 is assumed. In a case where the ventilation type silencer 10 is operated, a high-temperature and high-humidity gas flows in the flow passage space 24. In a case where the porous sound absorbing material 22 does not have the communication path 26, the gas flowing in the flow passage space 24 is blocked by the porous sound absorbing material 22 and does not flow into the rear space 30. Meanwhile, a large number of fine holes are formed in the porous sound absorbing material 22. For example, in the case of sound absorbing urethane, the porous sound absorbing material 22 has an open-cell structure and allows minute steam to pass therethrough. Therefore, the humidity of the flow passage space 24 is transmitted to the rear space 30. Since heat of the gas flowing in the flow passage space 24 is insulated by the porous sound absorbing material 22, the heat is not sufficiently transmitted to the rear space 30. Accordingly, in the rear space 30, blowing (forced convection) does not occur, and the rear space 30 is likely to have a low temperature and high humidity. As a result, condensation occurs in the rear space 30.

On the other hand, in the ventilation type silencer 10 which is an example of the embodiment of the present invention, the porous sound absorbing material 22 has the communication path 26. Thus, a high-temperature gas flowing in the flow passage space 24 flows into the rear space 30, the rear space 30 is unlikely to have a low temperature and high humidity, and occurrence of condensation in the rear space 30 is suppressed.

On the other hand, since the porous sound absorbing material 22 has the communication path 26, the corner portion 26a is formed at a connection position between the first surface 22a of the porous sound absorbing material 22 and the inner peripheral surface of the communication path 26. In general, it is not preferable to provide a pointed portion such as the corner portion 26a in the flow passage space since the provision promotes generation of wind noise and a pressure loss.

However, in the ventilation type silencer 10 which is an example of the embodiment of the present invention, since the corner portion 26a is formed at the porous sound absorbing material 22, a gas enters the fine holes of the porous sound absorbing material 22 at the corner portion 26a, and generation of wind noise and a pressure loss is reduced.

As described above, in the ventilation type silencer 10 which is an example of the embodiment of the present invention, the occurrence of condensation in the rear space 30 can be suppressed, and the generation of wind noise and a pressure loss in the flow passage space 24 can be reduced.

In addition, in the ventilation type silencer 10, since the opening diameter of the communication path 26 is 1.0 mm to 50 mm, a gas is sufficiently transported from the flow passage space 24 to the rear space 30.

In addition, in the ventilation type silencer 10, permeability of the porous sound absorbing material 22 is preferably 1.0×10⁻¹³ m² to 5.0×10⁻⁹ m² or 13.0×10⁻⁹ m² to 1.0× 10⁻⁵ m², and more preferably 1.0×10⁻¹³ m² to 4.0×10⁻⁹ m² or 15.0×10⁻⁹ m² to 1.0×10⁻⁵ m².

Accordingly, in the corner portion 26a and an edge part thereof, a gas effectively enters the fine holes of the porous sound absorbing material 22, and the generation of wind noise and a pressure loss is further reduced. In particular, by setting the permeability to 1.0×10⁻¹³ m² or more, the generation of wind noise is reduced, and by setting the permeability to 1.0×10⁻⁵ m² or less, the generation of a pressure loss is reduced.

The permeability is given by K=Q×μ×L/(ΔP×A). Herein, the permeability is denoted by K (m²), flow rate of a fluid is denoted by Q (m³/s), the length of the flow passage is denoted by L (m), the cross-sectional area of the flow passage is denoted by A (m²), a pressure difference is denoted by ΔP (Pa), and viscosity is denoted by μ (Pa·s).

In a case of measuring the permeability of the porous sound absorbing material (sound absorbing material), first, the permeability can be measured by applying a pressure to the sound absorbing material with air and measuring flow rate at which the sound absorbing material leaks out. A method of measuring the permeability is standardized in “ASTM D737-Air Permeability of Textile Fabrics” or ISO 9237.

Accordingly, the measurement can be performed with a ventilation property tester conforming to these standards.

In these measuring methods, the permeability can be measured by applying air at a high pressure, such as in the ventilation property tester or a permeability test device, to the sound absorbing material and measuring the pressure and the flow rate at which the sound absorbing material leaks out. Examples of such a test device include “YG461E” manufactured by Ningbo Textile Instrument Factory.

The permeability may be acquired by performing numerical calculation on the air flowing in the structure acquired by SEM or X-ray CT scan through fluid calculation such as a CFD module of COMSOL to calculate the applied pressure and the outflowing flow rate.

The permeability of the porous sound absorbing material can be acquired with reference to the following documents.

https://www.comsol.com/blogs/computing-porosity-and-permeability-in-porous-media-with-a-submodel/.

In addition, in the ventilation type silencer 10, the above action is more preferably exhibited in a case where the housing 18 of the expansion portion 14 is made of a resin. In a case where the housing 18 of the expansion portion 14 is made of a resin, since thermal conductivity of the resin is low, heat of the flow passage space 24 is unlikely to be transmitted to the rear space 30 via the housing 18. Thus, the inside of the rear space 30 is likely to have a low temperature and high humidity, and a problem of occurrence of condensation is likely to occur. On the other hand, in the ventilation type silencer according to the embodiment of the present invention, even in a case where the housing 18 of the expansion portion 14 is made of a resin, heat of the flow passage space 24 is transmitted to the rear space 30 with a gas passing through the communication path 26, and thus the occurrence of condensation in the rear space 30 can be suppressed. In addition, the housing 18 made of a resin has a degree of freedom in design (degree of freedom of shape) larger than that of a housing made of a metal due to use of, for example, injection molding or a 3D printer, and is inexpensive.

In addition, in the ventilation type silencer 10, as in this example, in a case where the temperature of a gas flowing in the flow passage space 24 is higher than a temperature outside the expansion portion 14, an effect of the present invention can be further exhibited.

In addition, in the ventilation type silencer 10, since the communication path 26 is a through-hole, the communication path 26 can be easily processed.

### Other Examples of Embodiment

Although an example of the embodiment of the ventilation type silencer according to the embodiment of the present invention has been described above, the above embodiment is merely an example for facilitating understanding of the present invention, and the present invention is not limited thereto. That is, the present invention can be changed and improved without departing from the gist thereof. In addition, it is evident that the present invention naturally includes equivalents thereof.

### Modification Example 1

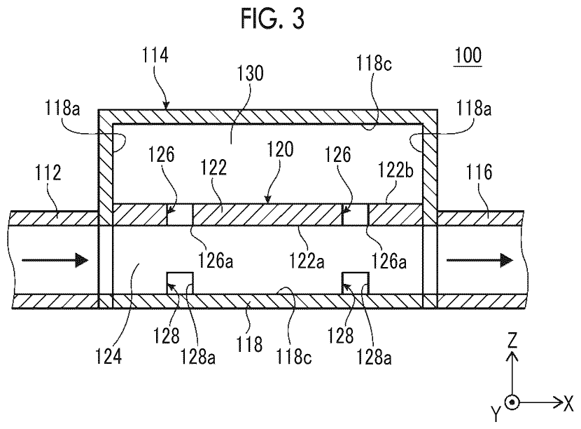

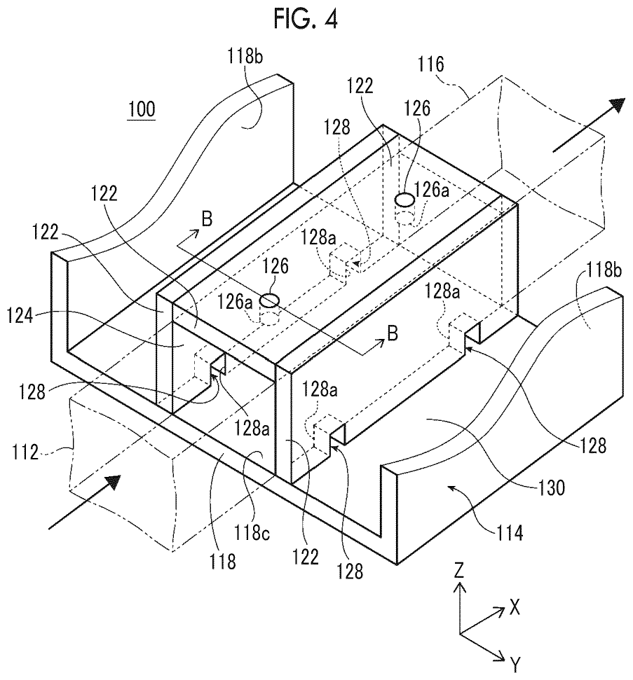

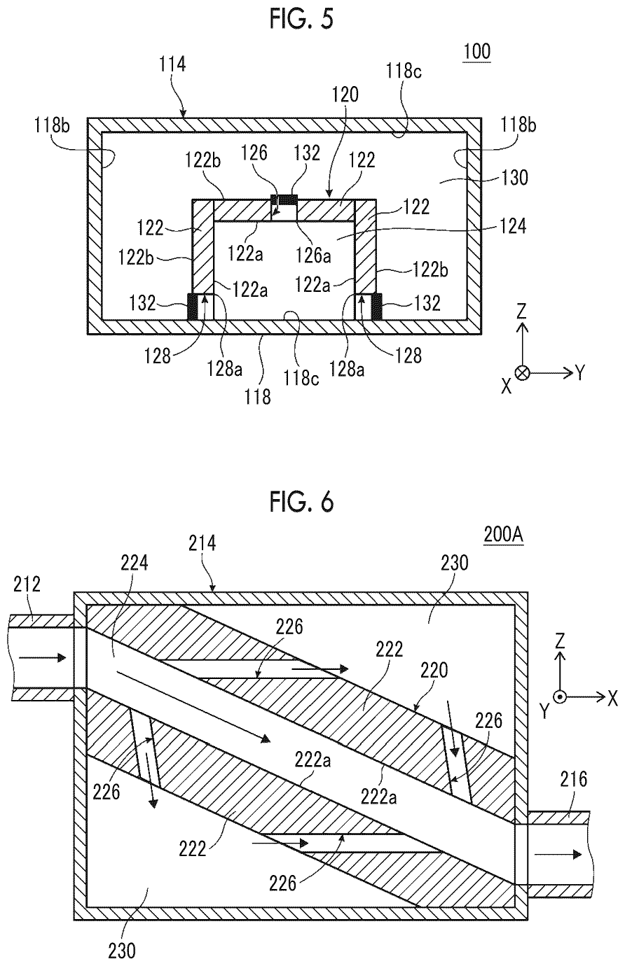

A ventilation type silencer 100, which is another example of the embodiment of the present invention, will be described with reference to FIGS. 3 to 5. FIG. 3 is a cross-sectional view conceptually showing another example of the ventilation type silencer according to the embodiment of the present invention. FIG. 4 is a perspective view conceptually showing the ventilation type silencer of FIG. 3. FIG. 5 is a cross-sectional view taken along line B-B of FIG. 4. In the following description, differences from the example of the embodiment described above will be described, and redundant points will not be described.

### Ventilation Pipe

As shown in FIG. 3, an inlet side ventilation pipe 112 and an outlet side ventilation pipe 116 are connected by shifting a central axis to one side (a lower side in FIG. 3) from a central position of an expansion portion 114 in the Z-direction. In this example, cross sections of the inlet side ventilation pipe 112 and the outlet side ventilation pipe 116 are rectangular as shown in FIG. 4.

### Flow Passage Wall

As shown in FIGS. 3 to 5, a flow passage wall 120 is composed of three porous sound absorbing materials 122 and a part (herein, a bottom wall) of a housing 118. More specifically, the flow passage wall 120 is composed of a pair of porous sound absorbing materials 122 disposed at an interval in the Y-direction and the bottom wall of the housing 118 and a porous sound absorbing material 122 which are disposed at an interval in the Z-direction. In other words, the pair of porous sound absorbing materials 122 facing each other in the Y-direction is disposed on the bottom wall of the housing 118, and the porous sound absorbing material 122 facing the bottom wall of the housing 118 in the Z-direction are connected to respective end parts of the pair of porous sound absorbing materials 122 on a side opposite to the bottom wall of the housing 118. Ends of the three porous sound absorbing materials 122 in the X-direction each are in contact with a surface 118a of the housing 118 on the inner side. With such a configuration, the flow passage wall 120 partitions a flow passage space 124 from an inner space in the housing 118.

A cross section of the flow passage space 124 in the flow passage wall 120 perpendicular to the X-direction is rectangular. An inner surface of the flow passage space 124 is composed of four surfaces and is composed of a first surface 122a of each of the three porous sound absorbing materials 122 and a surface 118c of the housing 118. More specifically, the inner surface of the flow passage space 124 is composed of the first surface 122a of the porous sound absorbing material 122 and the surface 118c of the housing 118 that face each other in the Z-direction and the first surface 122a of each of the pair of porous sound absorbing materials 122 that face each other in the Y-direction.

### Rear Space

A rear space 130 is positioned on the rear surface side of the three porous sound absorbing materials 122. The rear space 130 is disposed to surround the three porous sound absorbing materials 122 and more specifically, is surrounded by second surfaces 122b on an outer side (rear space 130 side) of the three porous sound absorbing materials 122 and surfaces 118a, 118b, and 118c of the housing 118.

### Communication Path

As shown in FIG. 4, communication paths 126 and 128 are formed in the three first surfaces 122a of the porous sound absorbing materials 122 constituting the inner surface of the flow passage space 124, respectively. Each of the communication paths 126 and 128 penetrates from the first surface 122a to the second surface 122b and causes the flow passage space 124 and the rear space 130 to communicate with each other.

More specifically, a plurality of (two in this example) communication paths 126 are provided in the porous sound absorbing material 122 disposed on one side (upper side in FIG. 3) in the Z-direction. The two communication paths 126 are provided in the first surface 122a at an interval along the flowing direction (X-direction) of a gas flowing in the flow passage space 124. The communication paths 126 are provided at a center of the first surface 122a in the Y-direction. The communication paths 126 are through-holes having a circular cross section perpendicular to the communication direction (Z-direction). Since details of the configurations of the communication paths 126 are the same as that of the communication path 26 shown in the above embodiment, description thereof will be omitted.

A corner portion 126a is formed at a connection point between an inner peripheral surface of the communication path 126 and the first surface 122a. The corner portion 126a extends along a circumferential direction around a central axis of the communication path 126 and surrounds a periphery of the communication path 126.

A plurality of (two in this example) communication paths 128 are formed in the pair of porous sound absorbing materials 122 disposed at an interval in the Y-direction, respectively. The two communication paths 128 are provided at an interval along the flowing direction (X-direction) of a gas flowing in the flow passage space 124. The communication path 128 is configured by cutting out one end of the porous sound absorbing material 122, more specifically, one end of the housing 118 on a bottom wall side in the Z-direction.

The communication path 128 is provided to be in contact with the surface 118c of the housing 118 (bottom wall). An inner surface of the communication path 128 is composed of four surfaces and is composed of a pair of surfaces of the porous sound absorbing material 122 that face each other in the X-direction and a surface of the porous sound absorbing material 122 and the surface 118c of the housing 118 that face each other in the Z-direction. As shown in FIG. 3, the communication path 128 penetrates (communicates) perpendicularly to the first surface 122a. The communication path 128 is a rectangular hole having a hollow rectangular parallelepiped shape and has a rectangular cross section perpendicular to the communication direction (Y-direction). The communication path 128 can also be referred to as a cutout portion having a rectangular cross section.

An equivalent circle opening diameter of the communication path 128 is preferably 1.0 mm to 50 mm and more preferably 3 mm to 20 mm. The term “equivalent circle” means that a shape other than a circular shape is imaginarily replaced with a circular shape based on an opening area.

In a case where the opening areas of the communication paths 126 and 128 are added up, the total is preferably 20 mm² or more, more preferably 20 to 2,000 mm², and still more preferably 30 to 500 mm². Herein, the opening areas of all the communication paths 126 and 128 communicating with one rear space 130 is a target. Therefore, in this example, the total refers to a value obtained by adding up all the opening areas of the two communication paths 126 and the four communication paths 128 communicating with one rear space 130.

The term “opening area” refers to an area at a position where the opening area is smallest in a case where the diameter of the communication path 126 changes in the communication direction.

In this example, the communication path 128 is a cutout portion formed in the porous sound absorbing material 122 in a post-process of a forming process (for example, foam forming) of the porous sound absorbing material 122, separately from the forming process. However, without being limited thereto, the communication path 128 may be integrally formed in the forming process of the porous sound absorbing material 122.

A corner portion 128a is formed at a connection point between an inner surface of the communication path 128 and the first surface 122a. The corner portion 128a extends along a circumferential direction around a central axis of the communication path 128 and surrounds a periphery of the communication path 128.

### Dust Filter

As shown in FIG. 5, a dust filters 132 is disposed in each of the communication paths 126 and 128. The dust filter 132 suppresses entry of dust and the like from the flow passage space 124 into the rear space 130. The dust filter 132 is, for example, a wire mesh, and an opening ratio of the dust filter 132 is, for example, preferably 20% to 95% in order to avoid an increase in a pressure loss in the flow passage space 124.

In this example, the dust filter 132 is disposed at an end part of each of the communication paths 126 and 128 on a second surface 122b side. It is preferable that the dust filter 132 is not disposed at the corner portions 126a and 128a (end parts of the communication paths 126 and 128 on a first surface 122a side) in order to suppress the generation of wind noise and a pressure loss in the flow passage space 124.

### Action and Effect

As described above, in the ventilation type silencer 100, since the total of the opening areas of the plurality of communication paths 126 and 128 is 20 mm² or more, a gas is sufficiently transported from the flow passage space 124 to the rear space 130.

In addition, in the ventilation type silencer 100, the plurality of communication paths 126 and 128 are provided at an interval along the flowing direction (X-direction) of a gas flowing in the flow passage space 124. Accordingly, the gas flows into the rear space 130 from the flow passage space 124 through the communication paths 126 and 128 on the upstream side in the flowing direction, and the gas flows out from the rear space 130 to the flow passage space 124 through the communication paths 126 and 128 on the downstream side in the flowing direction. As described above, since the gas in the flow passage space 124 smoothly enters and exits the rear space 130, occurrence of condensation in the rear space is further suppressed.

In addition, in the ventilation type silencer 100, since the dust filter 132 is disposed in each of the communication paths 126 and 128, the entry of dust and the like into the rear space 130 can be reduced.

In addition, in the ventilation type silencer 100, the inner surface of the flow passage space 124 is composed of the first surfaces 122a of the porous sound absorbing materials 122 and the surface 118c of the housing 118, and the housing 118 can be used as a part of the flow passage space 124. With the above configuration, a degree of freedom of disposing the flow passage space 124 in the housing 118 can be improved. Further, in the above configuration, since a gas in the flow passage space 124 is in contact with the surface 118c of the housing 118, heat of the gas in the flow passage space 124 can be transmitted to the rear space 130 via the housing 118, compared to a case where the entire inner surface of the flow passage space 124 is composed of the surfaces of the porous sound absorbing materials 122. As a result, the occurrence of condensation in the rear space 130 can be further suppressed.

In addition, since the communication path 128 is provided to be in contact with the surface 118c of the housing 118, a flow passage resistance of the inner surface of the communication path 128 can be decreased compared to a case where the entire inner surface of the communication path 128 is composed of the surface of the porous sound absorbing material 122. As a result, a gas is smoothly transported from the flow passage space 124 to the rear space 130, and the occurrence of condensation in the rear space 130 can be further suppressed.

In addition, in the ventilation type silencer 100, the communication paths 126 and 128 are formed in the three first surfaces 122a of the porous sound absorbing materials 122 constituting the inner surface of the flow passage space 124, respectively. Accordingly, the number of communication paths 126 and 128 is secured, and a gas is smoothly transported from the flow passage space 124 to the rear space 130. As a result, the occurrence of condensation in the rear space 130 can be further suppressed.

### Modification Example 2

Although the flowing direction of a gas flowing in the flow passage space 24 matches the X-direction (the arrangement direction of the inlet side ventilation pipe 12, the expansion portion 14, and the outlet side ventilation pipe 16) in the ventilation type silencer 10 described in the above embodiment, without being limited thereto, the flowing direction may be different from the X-direction.

For example, as in a ventilation type silencer 200A shown in FIG. 6, a central axis of an inlet side ventilation pipe 212 may be positioned on one side (upper side of FIG. 6) of a central position of an expansion portion 214 in the Z-direction, and a central axis of an outlet side ventilation pipe 216 may be positioned on the other side (lower side of FIG. 6) of the central position of the expansion portion 214 in the Z-direction. In this case, a flow passage wall 220 is connected to the inlet side ventilation pipe 212 and the outlet side ventilation pipe 216, and a flow passage space 224 is inclined from one side to the other side (lower side of FIG. 6) in the Z-direction as being closer in the X-direction. As shown in FIG. 6, a rear space 230 may have a hollow triangular prism shape extending in the Y-direction due to the inclination of the flow passage wall 220, and a communication path 226 may be a through-hole that penetrates at an inclination with respect to a first surface 222a of the porous sound absorbing material 222.

### Modification Example 3

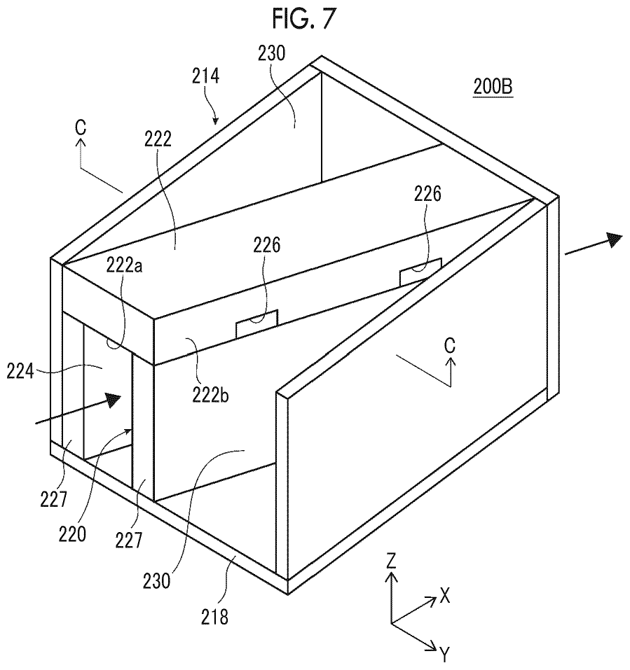

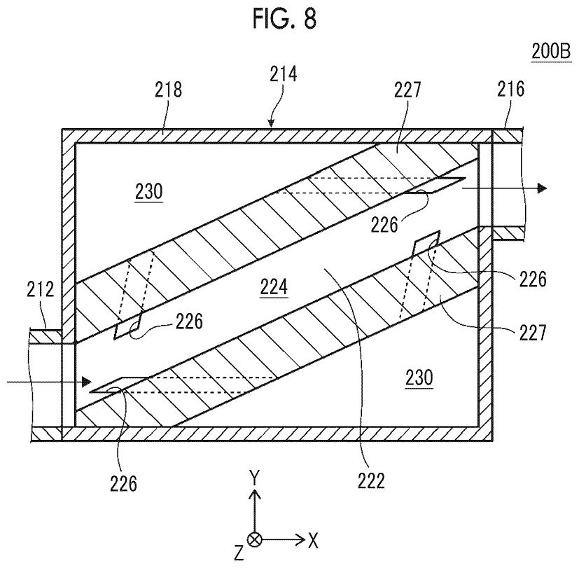

Next, a ventilation type silencer 200B, which is still another example of the embodiment of the present invention, will be described with reference to FIGS. 7 and 8. FIG. 7 is a perspective view conceptually showing still another example of the ventilation type silencer according to the embodiment of the present invention. FIG. 8 is a cross-sectional view taken along line C-C of FIG. 7. In FIG. 7, a part of a wall constituting the inlet side ventilation pipe 212, the outlet side ventilation pipe 216, and a housing 218 is not shown. Specifically, the part of the wall constituting the housing 218 is a side wall on an inlet side ventilation pipe 212 side in the X-direction and an upper wall positioned above in the Z-direction.

In the ventilation type silencer 200B, as shown in FIG. 7, the central axis of the inlet side ventilation pipe 212 is positioned on one side of a central position of the expansion portion 214 in the Y-direction, and the central axis of the outlet side ventilation pipe 216 is positioned on the other side of the central position of the expansion portion 214 in the Y-direction. Accordingly, the flow passage space 224 is inclined from the one side to the other side in the Y-direction as being closer in the X-direction.

As shown in FIG. 7, the flow passage wall 220 is composed of two interior walls 227 constituting a side wall, the porous sound absorbing material 222 constituting an upper wall, and a part (bottom wall) of the housing 218 constituting a lower wall. More specifically, the flow passage wall 220 is composed of a pair of interior walls 227 disposed at an interval in a direction orthogonal to a flowing direction of a gas flowing in the flow passage space 224 and the porous sound absorbing material 222 and a part of the housing 218 which are disposed at an interval in the Z-direction.

In this example, the interior wall 227 is, for example, a non-porous metal plate having no fine holes and has a rectangular shape in plan view as shown in FIG. 7 in a case of being viewed from the side.

The porous sound absorbing material 222 constituting the upper wall of the flow passage wall 220 is a plate member extending along the flowing direction of a gas as shown in FIG. 7. Both ends of the porous sound absorbing material 222 in the flowing direction are in contact with a pair of side walls of the housing 218 facing each other in the X-direction, respectively. In addition, an end (side surface) of the porous sound absorbing material 222 in the direction orthogonal to the flowing direction extends to a side surface of each of the pair of interior walls 227 on the outer side. An upper surface of the porous sound absorbing material 222 is in contact with the upper wall of the housing 218 (not shown) in FIG. 7.

As shown in FIG. 7, a lower surface of the porous sound absorbing material 222 is the first surface 222a in contact with a gas in the flow passage space 224, and the side surface of the porous sound absorbing material 222 in the direction orthogonal to the flowing direction is a second surface 222b in contact with a gas in the rear space 230.

As shown in FIGS. 7 and 8, the rear space 230 is positioned on a back side of each of the two interior walls 227. As shown in FIG. 7, the rear space 230 is a triangular prism-shaped space extending in the Z-direction.

The porous sound absorbing material 222 has a plurality of (four in this example) communication paths 226 that penetrate from the first surface 222a to the second surface 222b and that cause the flow passage space 224 and the rear space 230 to communicate with each other.

More specifically, the communication path 226 is configured by cutting out a lower end of the second surface 222b of the porous sound absorbing material 222 and extends from the second surface 222b to the flow passage space 224 beyond the interior wall 227 as shown in FIG. 8. The communication path 226 is a recessed portion (depressed portion) in which a flow passage space 224 side is open in the Z-direction. As shown in FIG. 8, the open end of the communication path 226 is covered with the interior wall 227 except for a region facing the flow passage space 224. The flow passage space 224 and the rear space 230 communicate with each other through the communication path 226 configured as described above.

The four communication paths 226 are provided at intervals along the flowing direction of a gas flowing in the flow passage space 224. More specifically, as shown in FIG. 8, two communication paths 226 are provided on both sides with the flow passage space 224 interposed therebetween on an upstream side in the flowing direction, and two communication paths 226 are provided on both sides with the flow passage space 224 interposed therebetween on a downstream side in the flowing direction of a gas flowing in the flow passage space 224.

The two communication paths 226 positioned on the upstream side extend in an inclined manner with respect to the flowing direction to approach the rear spaces 230 from the flow passage space 224 as the downstream side is reached. Accordingly, a gas flowing from the inlet side ventilation pipe 212 smoothly flows into the communication paths 226, and the gas is smoothly transported from the flow passage space 224 to the rear spaces 230. In particular, the communication path 226 (the communication path 226 on a lower side of FIG. 8) on the inlet side ventilation pipe 212 side in the Y-direction extends substantially parallel to the flowing direction (X-direction) of a gas flowing in the inlet side ventilation pipe 212. For this reason, the gas flowing from the inlet side ventilation pipe 212 smoothly flows into the communication path 226.

The two communication paths 226 positioned on the downstream side extend in an inclined manner with respect to the flowing direction to approach the flow passage space 224 from the rear spaces 230 as the downstream side is reached. Accordingly, a gas smoothly flows from the rear spaces 230 into the communication paths 226, and the gas is smoothly returned from the rear spaces 230 to the flow passage space 224. In particular, the communication path 226 (the communication path 226 on an upper side of FIG. 8) on an outlet side ventilation pipe 216 side in the Y-direction extends substantially parallel to the flowing direction (X-direction) of a gas flowing in the outlet side ventilation pipe 216. For this reason, the gas flowing from the communication path 226 smoothly flows out to the outlet side ventilation pipe 216.

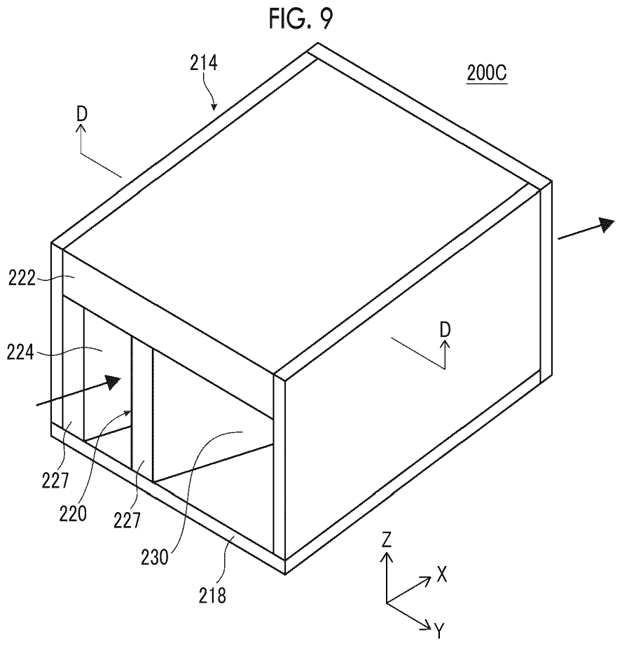

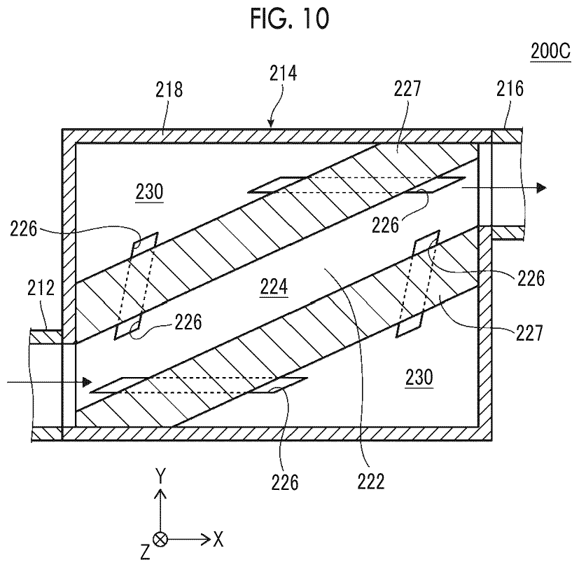

In the ventilation type silencer 200B shown in FIGS. 7 and 8, an end (side surface) of the porous sound absorbing material 222 in the direction orthogonal to the flowing direction extends to a side surface of each of the pair of interior walls 227 on the outer side. However, without being limited thereto, for example, as in a ventilation type silencer 200C shown in FIGS. 9 and 10, the porous sound absorbing material 222 may fill an upper space of the housing 118. That is, four side surfaces of the porous sound absorbing material 222 may be in contact with four side walls of the housing 218, respectively. The upper surface of the porous sound absorbing material 222 is in contact with the upper wall of the housing 118.

In this case, the communication path 226 is provided in the lower surface of the porous sound absorbing material 222 and forms a recessed portion (depressed portion) in which the flow passage space 224 and a rear space 230 side are open in the Z-direction as shown in FIG. 10. The communication path 226 extends from the flow passage space 224 to the rear space 230 with the interior wall 227 interposed therebetween, and the open end of the communication path 226 is covered with the interior wall 227 except for regions facing the flow passage space 224 and the rear space 230 as shown in FIG. 10. The flow passage space 224 and the rear space 230 may communicate with each other through the communication path 226 configured as described above.

In addition, in the ventilation type silencer 200B shown in FIGS. 7 and 8, the interior wall 227 is a metal plate formed of a non-porous material having no fine holes, but may be formed of a porous sound absorbing material. For example, as in a ventilation type silencer 200D shown in FIG. 11, a part of the interior wall 227, specifically, a central region in the Y-direction may be replaced with a porous sound absorbing material 228. In FIG. 11, as in FIG. 7, a part of the wall constituting the inlet side ventilation pipe 212, the outlet side ventilation pipe 216, and the housing 218 is not shown, and one side (front side of FIG. 11) of a pair of side walls of the housing 218 facing the Y-direction is also omitted.

The porous sound absorbing material 228 included in the interior wall 227 extends in the Z-direction from the porous sound absorbing material 222 constituting the upper wall of the flow passage wall 220 to the bottom wall of the housing 218 and is a rectangular plate member having the Z-direction as a longitudinal direction thereof.

The porous sound absorbing material 228 is provided with a communication path 228a obtained by cutting out a lower end of the porous sound absorbing material 228 in the Z-direction. The communication path 228a penetrates the porous sound absorbing material 228 to cause the flow passage space 224 and the rear space 230 to communicate with each other. A cross section of the communication path 228a perpendicular to the communication direction is rectangular as shown in FIG. 11.

The communication path 228a may be provided by cutting out an upper end in the Z-direction, may be provided at both the upper end and the lower end, may be provided at a center in the Z-direction, or may be provided at any position of the porous sound absorbing material 228. In addition, the cross section of the communication path 228a perpendicular to the communication direction is rectangular in the example shown in FIG. 11, but without being limited thereto, may have various shapes such as a circular shape and a triangular shape.

### (Other) Modification Examples

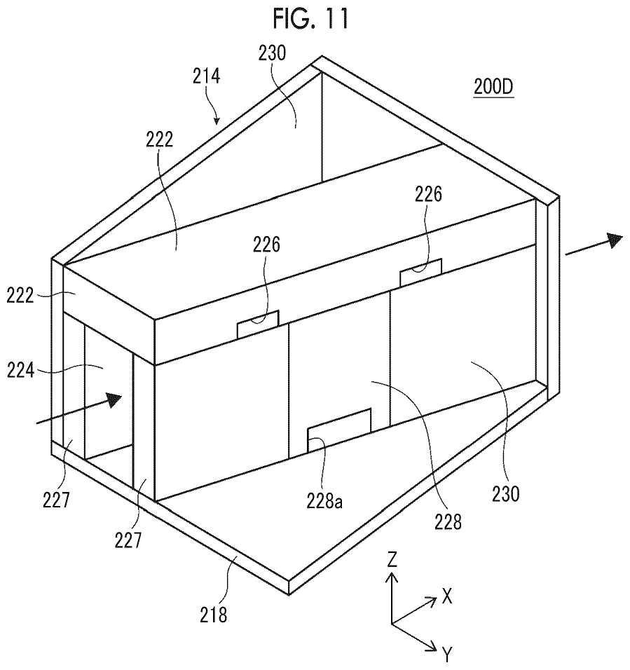

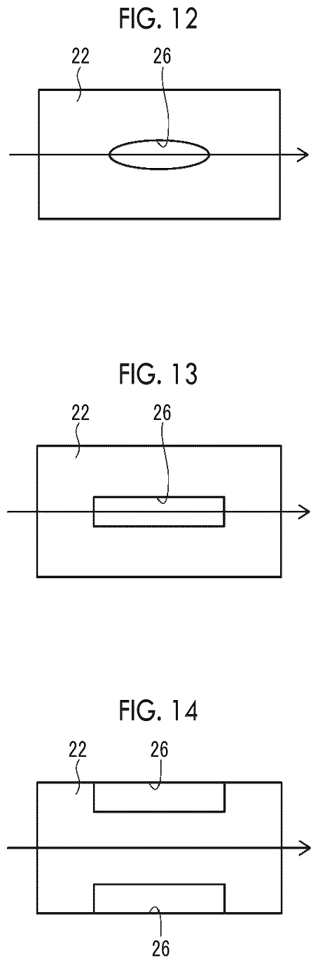

In the ventilation type silencer 10 shown in the example of the above embodiment, the cross section of the communication path 26 (see FIGS. 1 and 2) perpendicular to a penetration direction is circular, but without being limited thereto, may have various shapes such as a rectangular shape and a triangular shape. For example, the shape may be an elliptical shape as shown in FIG. 12 or a rectangular shape as shown in FIG. 13.

In addition, in the ventilation type silencer 10 shown in the example of the above embodiment, the communication path 26 is provided at the center of the first surface 22a as shown in FIG. 1, but without being limited thereto, for example, as shown in FIG. 14, the communication paths 26 may be disposed at both ends of the porous sound absorbing material 22 in a direction orthogonal to the flowing direction of a gas.

In addition, in the ventilation type silencer 10 shown in the example of the above embodiment, the communication path 26 is a through-hole that penetrates the first surface 22a perpendicularly, but without being limited thereto, may penetrate the first surface 22a obliquely.

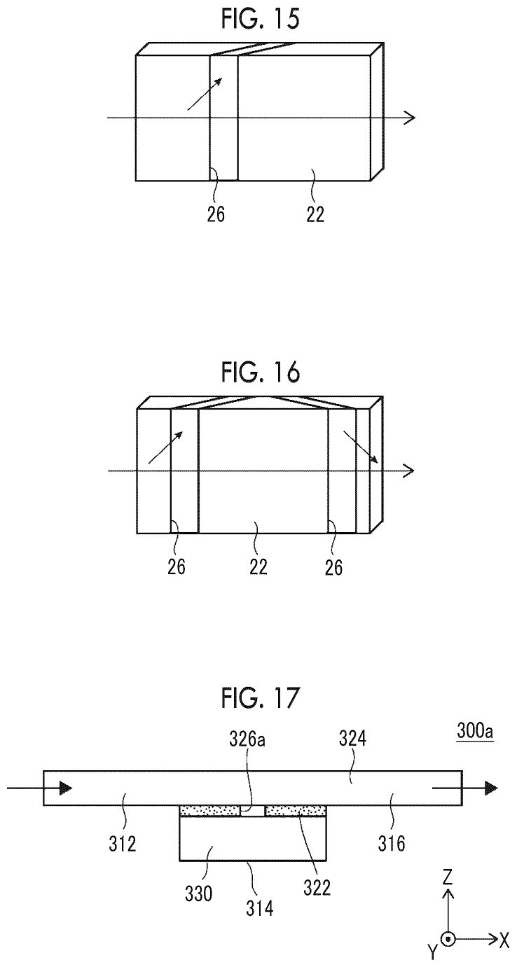

For example, as shown in FIG. 15, the communication path 26 may obliquely penetrate the porous sound absorbing material 22 toward the flowing direction of a gas with respect to the side surface of the porous sound absorbing material 22. In particular, as shown in FIG. 16, in the two communication paths 26 that are provided at an interval along the flowing direction of a gas, a direction in which each of the communication paths 26 penetrates may be changed. That is, the communication path 26 on the upstream side may be inclined with respect to the flowing direction to penetrate the porous sound absorbing material 22 such that the communication path 26 approaches the rear space from the flow passage space as the downstream side is reached. The communication path 26 on the downstream side may be inclined with respect to the flowing direction to penetrate the porous sound absorbing material 22 such that the communication path 26 approaches the flow passage space from the rear space as the downstream side is reached. In other words, the communication path 26 may be provided with respect to the porous sound absorbing material 22 at an angle at which a gas is likely to flow into the flow passage space and the gas is likely to flow out of the rear space.

In addition, the cross section of the communication path 26 perpendicular to the penetration direction is circular, but the cross-sectional shape of the communication path 26 may not be constant in the communication direction of the communication path 26. For example, the diameter of the communication path 26 may be changed in the communication direction, and for example, the communication path 26 may be tapered in the communication direction.

In addition, the number of communication paths 26 is not limited to one or two, and the porous sound absorbing material 22 may have a plurality (three or more) of communication paths 26.

In addition, in the ventilation type silencer 10 shown in the example of the above embodiment, the communication path 26 is provided at each of the pair of porous sound absorbing materials 22 disposed at an interval in the Z-direction constituting the upper wall and the lower wall of the flow passage wall 20 (see FIGS. 1 and 2). However, without being limited thereto, the communication path may be provided in any region of the porous sound absorbing material constituting the flow passage wall in any shape, and for example, the porous sound absorbing material shown in FIGS. 12 to 16 may be disposed in any region of the flow passage wall.

In addition, in the ventilation type silencer 10 shown in the example of the above embodiment, the flow passage wall 20 is composed of the two porous sound absorbing materials 22 (see FIGS. 1 and 2), but without being limited thereto, for example, the flow passage wall may include one porous sound absorbing material, and the other may be included in the housing. In the following examples, the flow passage wall is composed of one porous sound absorbing material and a housing.

### EXAMPLES

Hereinafter, the present invention will be described in more detail based on examples. Materials, amounts used, ratios, the content of processing, processing procedures, and the like shown in the examples below can be changed as appropriate without departing from the gist of the present invention. Therefore, the scope of the present invention is not to be construed as limiting by the examples shown below.

### Example 1

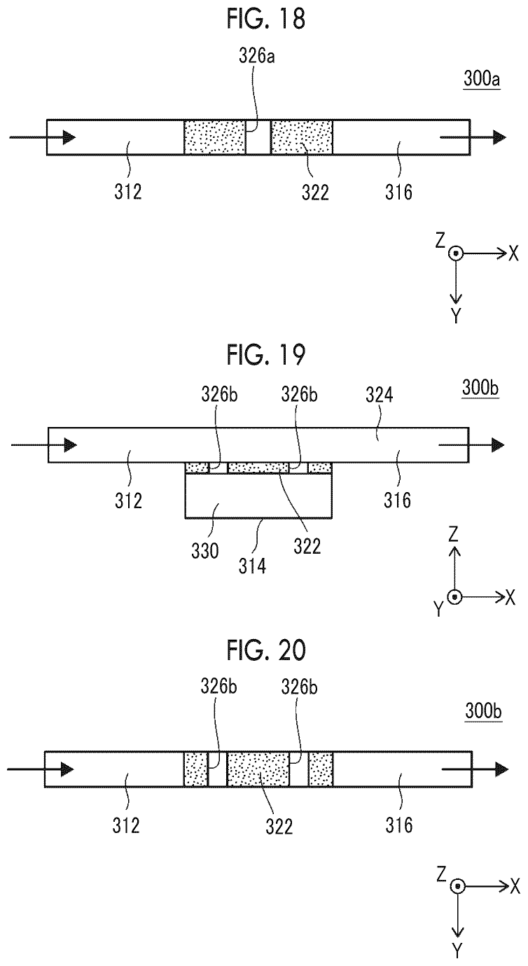

As shown in FIGS. 17 and 18, a ventilation type silencer 300a in which a porous sound absorbing material 322 is disposed in an expansion portion 314 is produced. FIG. 17 is a front view conceptually showing a ventilation type silencer of example 1 of the present invention, and FIG. 18 is a plan view conceptually showing the ventilation type silencer of example 1 of the present invention.

An inlet side ventilation pipe 312 and an outlet side ventilation pipe 316 are connected to the expansion portion 314 at the front and rear thereof in the X-direction, and the inlet side ventilation pipe 312, a flow passage space 324 of the expansion portion 314, and the outlet side ventilation pipe 316 are composed of one long tubular duct. The tubular duct is formed of a duct having a rectangular cross section perpendicular to the X-direction, the cross section having an inner dimension of 25 mm in the Y-direction×25 mm in the Z-direction. A silencing portion that has a box shape having an inner dimension of 100 mm in the X-direction×25 mm in the Y-direction×40 mm in the Z-direction and that has a surface on a tubular duct side open is attached to a center portion of the tubular duct in the X-direction.

The porous sound absorbing material 322 (foaming urethane foam, CALMFLEX F-2 manufactured by INOAC Corporation) having a size of 100 mm in the X-direction×25 mm in the Y-direction×10 mm in the Z-direction (thickness direction) is disposed at an end part of the silencing portion on the tubular duct side. Permeability of the porous sound absorbing material 322 is 3.5×10⁻⁹ m².

A communication path 326a having a size of 20 mm in the X-direction×25 m in the Y-direction is provided at a center of the porous sound absorbing material 322 in the X-direction to cause the flow passage space 324 and a rear space 330 to communicate each other.

### Example 2

A ventilation type silencer 300b having the same structure as that of example 1 except that two communication paths 326b of which a dimension in the X-direction is narrowed to 10 mm are arranged along the X-direction, instead of the communication path 326a, is produced (see FIGS. 19 and 20).

### Example 3

A ventilation type silencer (not shown) having the same structure as that of example 1 except that a communication path of which a dimension in the X-direction is expanded to 40 mm is disposed, instead of the communication path 326a, is produced.

### Comparative Example 1

A ventilation type silencer (not shown) having the same structure as that of example 1 except that a non-porous plate material having the same dimensions as those of the porous sound absorbing material 322 is disposed, instead of the porous sound absorbing material 322, is produced. A communication path having a size of 20 mm in the X-direction×25 mm in the Y-direction is provided at a center of the non-porous plate material to cause the flow passage space 324 and the rear space 330 to communicate with each other, as in example 1.

### Comparative Example 2

A ventilation type silencer (not shown) having the same structure as that of example 1 except that the communication path 326a is not provided at the center of the porous sound absorbing material 322 is produced. That is, the flow passage space and the rear space are not caused to communicate with each other through the communication path.

### Comparative Example 3

A ventilation type silencer (not shown) having the same structure as that of comparative example 1 except that the dimension of the communication path in the X-direction is expanded to 40 mm is produced.

### Evaluation

### (Vorticity)

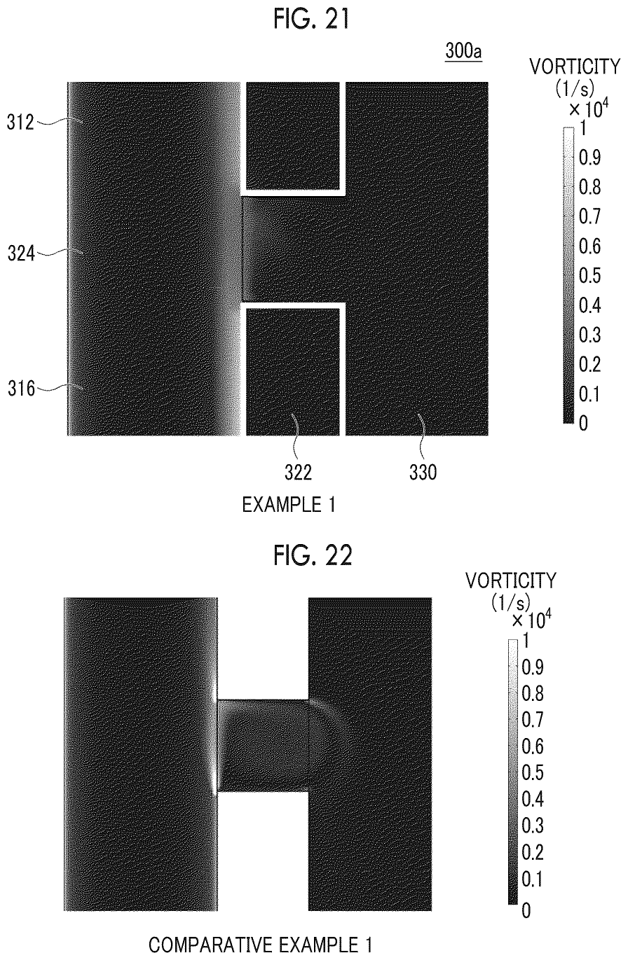

As shown in FIGS. 21 and 22, vorticities around the communication paths of the produced ventilation type silencers of example 1 and comparative example 1 are measured. FIG. 21 shows the vorticity in example 1, and FIG. 22 shows the vorticity in comparative example 1. From the results of FIGS. 21 and 22, it can be seen that at the corner portion (edge) of the communication path, vortices are generated (the vorticity is high) in comparative example 1, but generation of vortices is reduced (the vorticity is low) in example 1 compared to comparative example. In example 1, it is presumed that the generation of the vortices is reduced because a gas has entered fine holes of the porous sound absorbing material 322.

### (Condensation)

Condensation is measured for the produced ventilation type silencers of examples 1 and 2 and comparative examples 1 and 2.

The measurement of condensation is performed by visually confirming the rear space and measuring a weight difference of the ventilation type silencer before and after the evaluation.

As a procedure, first, the weight of the ventilation type silencer before evaluation is measured. Thereafter, the ventilation type silencer is disposed in an insulating box (styrofoam box), and the atmosphere in the insulating box is adjusted to 7° C. to adapt the ventilation type silencer to the atmosphere temperature. Thereafter, air is caused to flow into the ventilation type silencer. The wind speed of the air is set to 10 m/s or 20 m/s, the temperature is set to 33° C., and the humidity is set to 65% RH. After continuing the inflow of the air for approximately 12 hours, the inflow of the air is stopped, and after being left to stand for approximately 30 minutes, the weight of the ventilation type silencer is measured.

As a result of the evaluation, condensation does not occur in the ventilation type silencers of examples 1 and 2 and comparative example 1, and condensation has occurred in comparative example 2. In a case where the rear space of comparative example 2 is visually confirmed, a visible moisture content is generated in the rear space. In comparative example 2, it is presumed that since the communication path is not provided, air in the flow passage space does not flow into the rear space, and thus condensation has occurred.

### (Transmittance and Transmission Loss)

Transmittance and a transmission loss are measured for the produced ventilation type silencers of examples 1 and 2 and comparative examples 1 and 2. The measurement is performed through four-terminal method measurement using an acoustic tube.

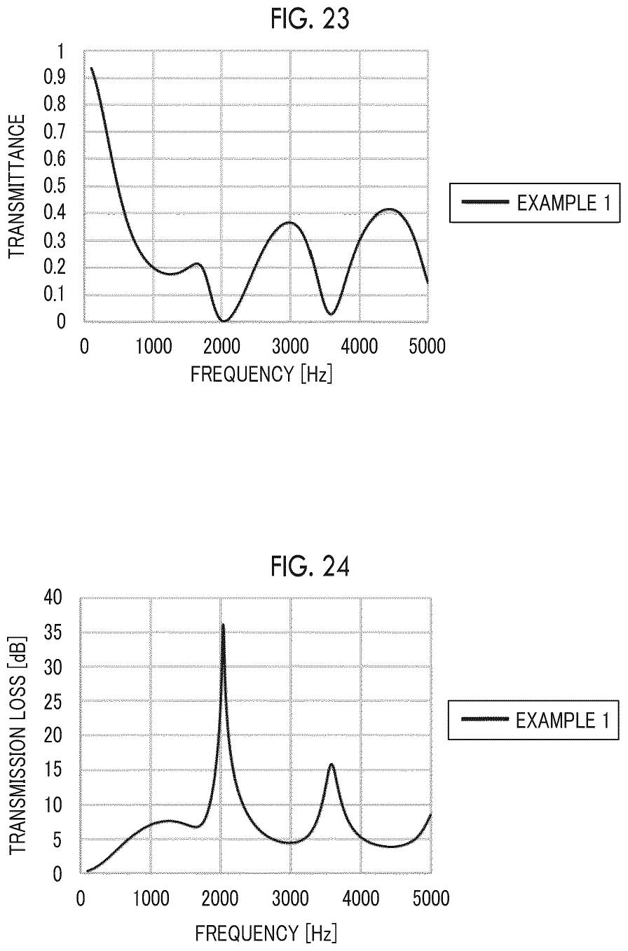

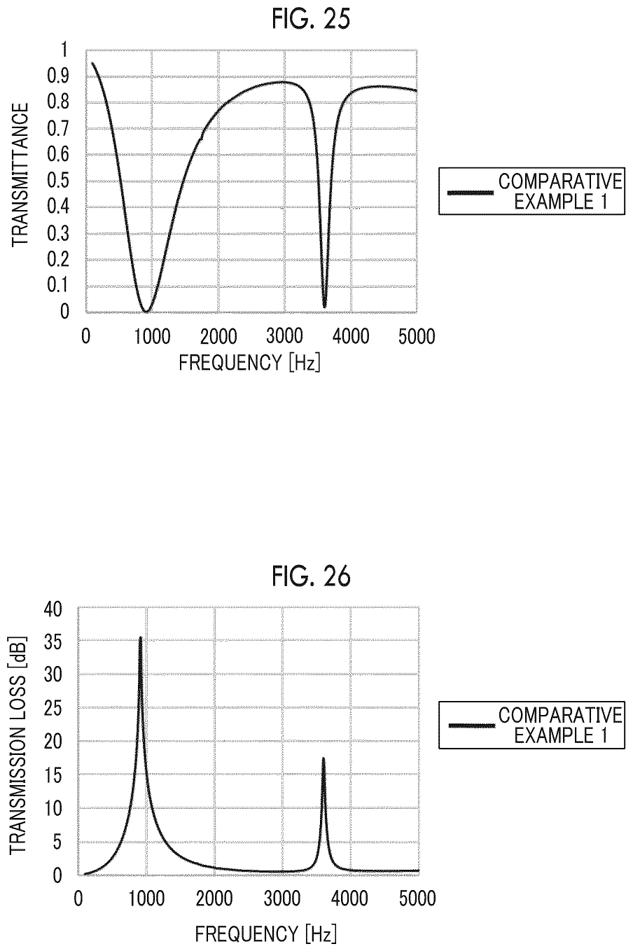

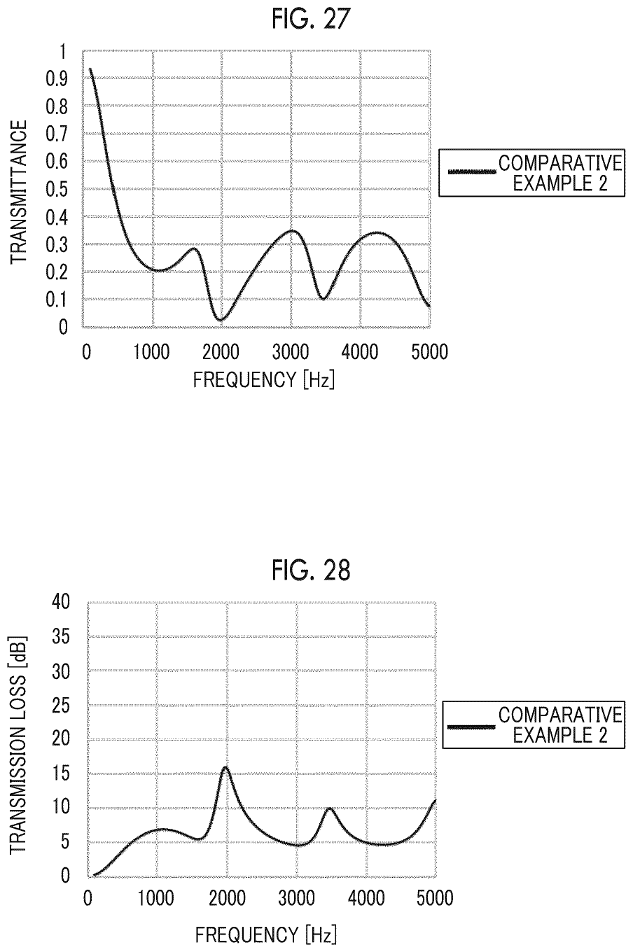

FIGS. 23 to 28 show measurement results of the transmittance and the transmission loss of example 1 and comparative examples 1 and 2. In graphs of FIGS. 23 to 28, a horizontal axis represents a frequency, and a vertical axis represents transmittance or a transmission loss. By comparing FIGS. 23 and 25, it is found that example 1 shows a silencing effect in a wide band compared to comparative example 1. In comparative example 1, since the non-porous plate material having the same dimensions as those of the porous sound absorbing material is disposed instead of the porous sound absorbing material, it is presumed that the silencing effect is small except for a resonance frequency since the non-porous plate material acts as a Helmholtz resonator.

In addition, in a case where FIG. 24 and FIG. 28 are compared, it is found that example 1 shows an excellent silencing effect in resonance characteristics compared to comparative example 2, and particularly shows a silencing effect on a low frequency side (for example, around 2 kHz). In example 1, since the porous sound absorbing material has the communication path, it is presumed that in addition to a sound absorbing effect of the porous sound absorbing material, the communication path and the rear space act as a Helmholtz resonator and resonate in the vicinity of 2 kHz, so that a silencing effect of the resonance is also obtained. On the other hand, in comparative example 2, since the porous sound absorbing material in which the communication path is not provided is used, resonance in the rear space does not occur, and only the sound absorbing effect of the porous sound absorbing material acts.

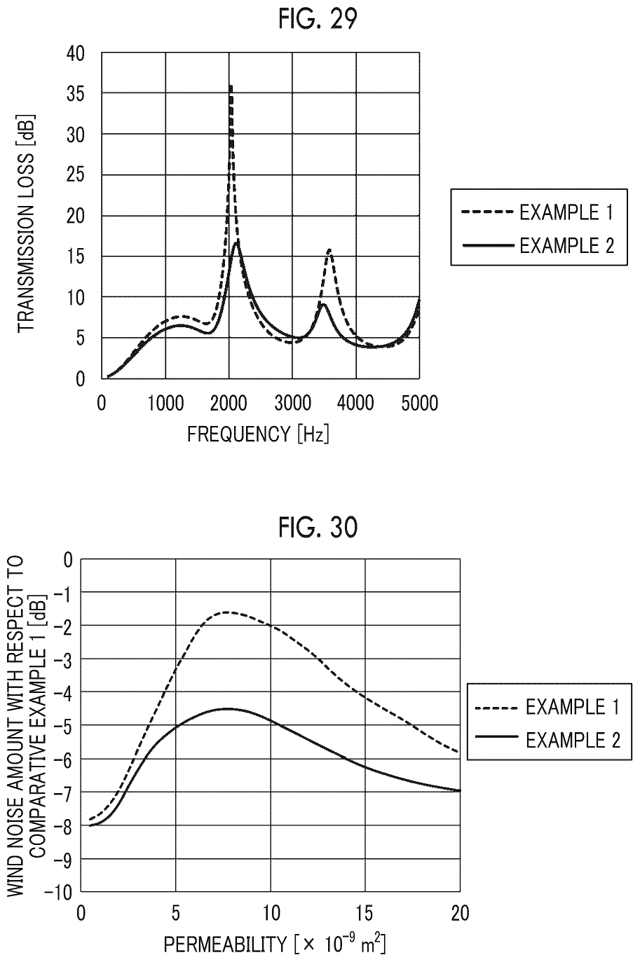

Next, the measurement results of the transmission loss of example 2 is shown in FIG. 29 in comparison with example 1. In the graph of FIG. 29, a horizontal axis represents a frequency, and a vertical axis represents a transmission loss. A broken line in the graph represents example 1, and a solid line represents example 2. As shown in FIG. 29, it is found that example 2 exhibit s the same silencing effect as in example 1 except for a band of the resonance frequency (for example, 2 kHz). On the contrary, in example 2, the silencing effect in the band of the resonance frequency is inferior to that in example 1.

On the other hand, with reference to FIG. 28, it can be said that the silencing effect in the band at the resonance frequency of example 2 is equal to or larger than that of comparative example 2 (the porous sound absorbing material in which the communication path is not provided). For example, at a frequency of 2 kHz, the transmission loss of example 2 is approximately 17 dB (see FIG. 29), whereas the transmission loss of comparative example 2 is approximately 16 dB (see FIG. 28). That is, it is found that, in example 2, although the silencing effect is smaller than that of example 1 in the band of the resonance frequency, the silencing effect that is equal to or larger than that of comparative example 2, in which the porous sound absorbing material is not provided with the communication path, is exhibited.

### (Wind Noise Amount)

Wind noise is measured for the produced ventilation type silencers of examples 1 and 2 and comparative examples 1 and 2.

As a procedure, first, air at 20 m/s is caused to flow into the ventilation type silencer. In this case, a silencing box in which a sound absorbing material fills between a blower fan and the ventilation type silencer is connected such that sound of the blower fan that is positioned on the upstream side of the flowing direction of the ventilation type silencer and that is for transporting air to the ventilation type silencer does not affect the measurement, silencing blowing sound from the blower fan.

The downstream side of the outlet side ventilation pipe is connected to a reverberation chamber, and the amount of wind noise generated by the ventilation type silencer is measured. In this case, in the reverberation chamber, a microphone is disposed at a position where air flowing out from the ventilation type silencer does not directly hit.

Wind noise amounts of examples 1 and 2 and comparative examples 1 and 2 are 40 dBA in example 1, 39 dBA in example 2, 45 dBA in comparative example 1, and 39 dBA in comparative example 2.

In example 1, it is found that a wind noise amount is 5 dB which is smaller than that of comparative example 1, and a wind noise amount is 1 dB which is larger than that of comparative example 2. It is said that generally almost all people can recognize a difference in volume in a case where the difference in wind noise amount is 3 dB or more. Therefore, from the results of example 1 and comparative example 1, it is found that reduction in the wind noise amount caused by a change from the non-porous plate material to the porous sound absorbing material is easily recognized by a person. On the other hand, from the results of example 1 and comparative example 2, it is found that it is difficult for a person to recognize an increase in the wind noise amount due to the provision of the communication path.

It is found that example 2 is 39 dB which is equivalent to comparative example 2 and can maintained the same wind noise amount as that of comparative example 2, in which the porous sound absorbing material not provided with the communication path.

### (Permeability)

A change in the wind noise amount with respect to the permeability of the porous sound absorbing material is estimated by simulation.

The permeability is acquired by performing numerical calculation on air flowing in a structure acquired by SEM or X-ray CT scan through fluid calculation such as a CFD module of COMSOL to calculate an applied pressure and outflowing flow rate.

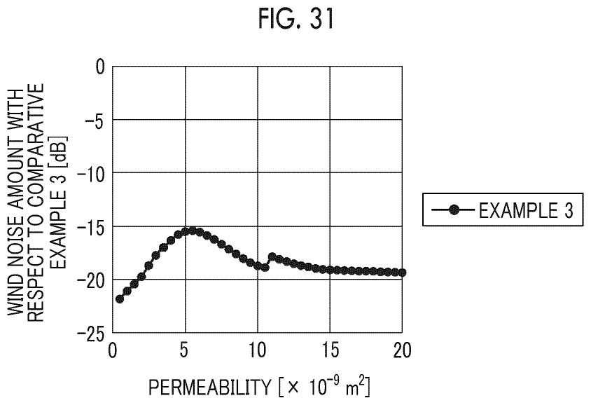

FIG. 30 is a graph showing a relationship between permeability and a wind noise amount in examples 1 and 2. A horizontal axis of the graph represents the permeability, and a vertical axis represents the wind noise amounts of examples 1 and 2 with respect to comparative example 1. A broken line in the graph represents example 1, and a solid line represents example 2.

As a result of simulation, it is found that, for example 1, the wind noise amount is smallest with respect to comparative example 1 at the permeability of 7.5×10⁻⁹ m² indicating a peak of the wind noise amount. As described above, it is said that a difference in volume can be generally recognized by almost all people in a case where the difference in the wind noise amount is 3 dB or more. In this estimation result, it is found that in a case where the permeability is 5.0×10⁻⁹ m² or less or 13.0×10⁻⁹ m² or more, example 1 is smaller than comparative example 1 by 3 dB or more.

It is found that, in example 2, the wind noise amount is smaller than that of example 1 in all the ranges of the permeability, compared to example 1. In particular, it is found that the wind noise amount is smaller than that of example 1 on a side larger than permeability of 7.5×10⁻⁹ m² indicating a peak of the wind noise amount.

FIG. 31 is a graph showing a relationship between permeability and a wind noise amount in example 3. A horizontal axis of the graph represents the permeability, and a vertical axis represents a wind noise amount of example 3 with respect to comparative example 3. FIG. 31 shows results in a case of the communication path in which a dimension in the X-direction is expanded to 40 mm as described above. As a result of simulation, the wind noise amount of example 3 is −15 dB with respect to comparative example 3 at permeability of 5.0×10⁻⁹ m² indicating a peak of the wind noise amount. As shown in FIG. 31, it can be seen that an effect of reducing the wind noise amount is large, whereas a peak value of the wind noise amount of example 1 is approximately −1.5 dB (position of permeability of 7.5×10⁻⁹ m²). That is, it is found that as the opening area of the communication path increases, the wind noise amount increases, but on the other hand, the effect of reducing the wind noise amount with the porous sound absorbing material 22 is also increased.

### Explanation of References

10, 100, 200A, 200B, 200C, 200D, 300a, 300b: ventilation type silencer
12, 112, 212, 312: inlet side ventilation pipe
14, 114, 214, 314: expansion portion
16, 116, 216, 316: outlet side ventilation pipe
18, 118: housing
18a, 18b, 18c, 118a, 118b, 118c: surface
20, 120, 220: flow passage wall
22, 122, 222, 228, 322: porous sound absorbing material
22a, 122a, 222a: first surface
22b, 122b, 222b: second surface
24, 124, 224, 324: flow passage space
26, 126, 128, 226, 228a, 326a, 326b: communication path
26a, 126a, 128a: corner portion
30, 130, 230, 330: rear space
132: dust filter
227: interior wall

What is claimed is:

1. A ventilation type silencer comprising:
an inlet side ventilation pipe;
an expansion portion that communicates with the inlet side ventilation pipe and that has a cross-sectional area larger than that of the inlet side ventilation pipe;
an outlet side ventilation pipe that communicates with the expansion portion and that has a cross-sectional area smaller than that of the expansion portion;
a flow passage wall that is disposed in the expansion portion, that causes the inlet side ventilation pipe and the outlet side ventilation pipe to communicate with each other, and that has at least a part including a porous sound absorbing material; and
a rear space that is positioned on a side opposite to a flow passage space in the flow passage wall with the flow passage wall interposed therebetween and that is defined by the flow passage wall and a housing of the expansion portion,
wherein the porous sound absorbing material has one or a plurality of communication paths that cause the flow passage space and the rear space to communicate with each other.

2. The ventilation type silencer according to claim 1,
wherein an equivalent circle opening diameter of the communication path is 1.0 mm to 50.0 mm.

3. The ventilation type silencer according to claim 1,
wherein permeability of the porous sound absorbing material is 1.0×10⁻¹³ m² to 5.0×10⁻⁹ m² or 13.0×10⁻⁹ m² to 1.0×10⁻⁵ m².

4. The ventilation type silencer according to claim 1,
wherein in a case where opening areas of the one or plurality of communication paths are added up, a total is 20 mm² or more.

5. The ventilation type silencer according to claim 1,
wherein the plurality of communication paths are provided at an interval along a flowing direction of a gas flowing in the flow passage space.

6. The ventilation type silencer according to claim 1,
a dust filter is disposed at the communication path.

7. The ventilation type silencer according to claim 1,
wherein the housing of the expansion portion is made of a resin.

8. The ventilation type silencer according to claim 1,
wherein a temperature of a gas flowing in the flow passage space is 20° C. to 80° C. and is high compared to a temperature outside the expansion portion.

9. The ventilation type silencer according to claim 1,
wherein an inner surface of the flow passage space is composed of a surface of the porous sound absorbing material and a surface of the housing of the expansion portion, and the communication path is provided to be in contact with the surface of the housing of the expansion portion.

10. The ventilation type silencer according to claim 1,
wherein the porous sound absorbing material has a first surface that is in contact with a gas in the flow passage space and a second surface that is in contact with a gas in the rear space, and
the one or plurality of communication paths penetrate from the first surface to the second surface.

11. The ventilation type silencer according to claim 1,
wherein a cross section of the flow passage space perpendicular to a flowing direction is rectangular,
an inner surface of the flow passage space is composed of a surface of each of the porous sound absorbing material and the housing which face each other in a first direction intersecting the flowing direction and a surface of each of a pair of the porous sound absorbing materials which face each other in a second direction intersecting the flowing direction and the first direction, and
the communication path is formed in each of three surfaces of the porous sound absorbing material, which constitute the inner surface of the flow passage space.

12. The ventilation type silencer according to claim 1.
wherein the communication path is a through-hole.

13. The ventilation type silencer according to claim 1.
wherein the communication path is configured by cutting out one end of the porous sound absorbing material.
